(19) United States
(12) Patent Application Publication
(10) Pub. No.: US 2018/0003560 A1
(43) Pub. Date: Jan. 4, 2018

(54) METHODS AND APPARATUS FOR MULTI-PROBE PHOTONIC TIME-STRETCH SPECTRAL MEASUREMENTS

(71) Applicants: MohammadHossein Asghari, Los Angeles, CA (US); Bahram Jalali, Los Angeles, CA (US); Paul Trinh, Lake Forest, CA (US)

(72) Inventors: MohammadHossein Asghari, Los Angeles, CA (US); Bahram Jalali, Los Angeles, CA (US); Paul Trinh, Lake Forest, CA (US)

(73) Assignees: The Regents of the University of California, Oakland, CA (US); Time Photonics, Inc., Irvine, CA (US)

(21) Appl. No.: 15/616,865

(22) Filed: Jun. 7, 2017

Related U.S. Application Data
(60) Provisional application No. 62/346,572, filed on Jun. 7, 2016.

(51) Int. Cl. G01J 3/28; G01B 9/02

(52) U.S. Cl. CPC G01J 3/2803; G01B 9/02091

(57) ABSTRACT

Methods and apparatus for multi-probe photonic time-stretch spectral measurements are described. Methods allow for capturing real-time and single-shot non-overlapping spectral bands from multiple probes simultaneously, using Time-Stretch Dispersive Fourier Transform (TS-DFT) systems combined with Wavelength Division Multiplexing (WDM) device.

### CROSS-REFERENCE TO RELATED APPLICATIONS

This application claims priority to, and the benefit of, U.S. provisional patent application Ser. No. 62/346,572 filed Jun. 7, 2016, the disclosure of which is incorporated herein by reference in its entirety.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### NOTICE OF MATERIAL SUBJECT TO COPYRIGHT PROTECTION

Not Applicable.

### BACKGROUND

### 1. Technical Field

This disclosure pertains generally to signal measurement, and more particularly to methods for optical spectral measurement.

### 2. Background Discussion

In many applications of interest, there is a need for capturing multiple single-shot events simultaneously. These applications, includes but not limited to multiple-probe Photonic velocimetry, multiple-probe Photon Doppler velocimetry (PDV), multiple-probe Photonic vibrometry, multiple-probe optical coherence tomography (OCT), multiple-probe optical imaging, multiple-probe Photonic vibrometry, multiple-probe Laser induced breakdown spectroscopy (LIBS), multiple-probe Optical Time Domain Reflectometry (OTDR), and/or multiple-probe LIDAR, etc.

The challenge is that conventional Time-Stretch Dispersive Fourier Transform (TS-DFT) systems can only support one probe per pulse. It is critical for the mentioned applications for that real-time and single-shot non-overlapping spectral bands are captured from multiple probes simultaneously.

### BRIEF SUMMARY OF INVENTION

Disclosed herein are apparatus, systems and/or methods to capture real-time and single-shot non-overlapping spectral bands from multiple probes simultaneously. In embodiments, a WDM device may be used to separate different spectral band of each input pulse and direct separated spectral bands to multiple probes. When combined with a reference signal and utilizing multi TS-DFT systems information about different probes may be captured in real-time and single-shot using digital post-processing.

Methods and apparatus for multi-probe photonic time-stretch spectral measurements are described herein. In embodiments, real-time and single-shot non-overlapping spectral bands from multiple probes are capture simultaneously, using one or more Time-Stretch Dispersive Fourier Transform (TS-DFT) systems combined with a Wavelength Division Multiplexing (WDM) device.

### BRIEF DESCRIPTION OF THE SEVERAL VIEWS OF THE DRAWING(S)

The disclosed technology will be more fully understood by reference to the following drawings which are for illustrative purposes only:

FIG. 1 illustrates a block diagram for implementation of the time-stretched spectrometer for measuring the source signal spectrum with absolute wavelength information for the application of time-stretch based distance measurement according to embodiments.

FIG. 2 illustrates a flowchart for one possible implementation of the digital post processing5 unit used in the block diagram for implementation of the time-stretched spectrometer for measuring the source signal spectrum with absolute wavelength information for the application of time-stretch based distance measurement according to embodiments.

FIG. 3 illustrates a flowchart for one possible implementation of the digital post processing5 unit used in the block diagram for implementation of the time-stretched spectrometer for measuring the source signal spectrum with absolute wavelength information for the application of time-stretch based velocity measurement according to embodiments.

FIG. 4 illustrates a flowchart for a block diagram for implementation of the time-stretched spectrometer for measuring the source signal spectrum with absolute wavelength information for the application of time-stretch based distance and velocity measurement with multiple probes/targets according to embodiments.

FIG. 5 illustrates a flowchart for one possible implementation of the digital post processing6 unit used in the block diagram for implementation of the time-stretched spectrometer for measuring the source signal spectrum with absolute wavelength information for the application of time-stretch based distance measurement for multiple probes/targets according to embodiments.

FIG. 6 illustrates a flowchart for one possible implementation of the digital post processing6 unit used in the block diagram for implementation of the time-stretched spectrometer for measuring the source signal spectrum with absolute wavelength information for the application of time-stretch based velocity measurement for multiple targets according to embodiments.

FIG. 7 illustrates a flowchart for a block diagram for implementation of the time-stretched spectrometer for measuring the source signal spectrum with absolute wavelength information for the application of real-time bit error rate measurement using time-stretch spectrometer with absolute wavelength according to embodiments.

FIG. 8 illustrates a flowchart for one possible implementation of the digital post processing6 unit used in the block diagram for implementation of the time-stretched spectrometer for measuring the source signal spectrum with absolute wavelength information for the application of real-time bit error rate measurement using time-stretch spectrometer with absolute wavelength according to embodiments.

FIG. 9 illustrates a block diagram for implementation of the time-stretched spectrometer for measuring the source signal spectrum with absolute wavelength information for the application of time-stretch camera according to embodiments.

FIG. 10 illustrates a block diagram for implementation of the time-stretched spectrometer for measuring the source signal spectrum with absolute wavelength information for the application of time-stretch camera with multiple probes/images according to embodiments.

FIG. 11 illustrates a block diagram for another implementation of the time-stretched spectrometer for measuring the source signal spectrum with absolute wavelength information for the application of time-stretch camera with multiple probes according to embodiments.

FIG. 12 illustrates a block diagram for implementation of the time-stretched spectrometer for measuring the source signal spectrum with absolute wavelength information for the application of coherent time-stretch camera according to embodiments.

FIG. 13 illustrates a block diagram for an implementation of the time-stretched spectrometer for measuring the source signal spectrum with absolute wavelength information for the application of coherent time-stretch camera with multiple probes according to embodiments.

FIG. 14 illustrates a block diagram for an implementation of the time-stretched spectrometer for measuring the source signal spectrum with absolute wavelength information for the application of coherent time-stretch camera with multiple probes according to embodiments.

FIG. 15 illustrates a block diagram for an implementation of the time-stretched spectrometer for measuring the source signal spectrum with absolute wavelength information for the application of time-stretch digitizer with multiple input RF channels according to embodiments.

FIG. 16 illustrates a block diagram for an implementation of the time-stretched spectrometer for measuring the source signal spectrum with absolute wavelength information for the application of time-stretch digitizer with multiple input RF channels.

FIG. 17 illustrates an example of β(ω) profile as a function of absolute frequency.

FIG. 18 illustrates an example dispersion factor dispersion parameter (Dλ) profile as a function of absolute wavelength variable.

FIG. 19 illustrates a block diagram for implementation of the time-stretched spectrometer for measuring the source signal spectrum with absolute wavelength information for the application of time-stretch based distance and velocity measurement with multiple probes/targets according to embodiments.

FIG. 20 illustrates a block diagram for implementation of the time-stretched spectrometer for measuring the source signal spectrum with absolute wavelength information for the application of time-stretch based distance and velocity measurement with multiple probes/targets according to embodiments.

FIG. 21 illustrates a block diagram for an implementation of the time-stretched spectrometer for measuring the source signal spectrum with absolute wavelength information for the application of time-stretch based distance measurement according to embodiments.

FIG. 22 illustrates a block diagram for an implementation of the time-stretched spectrometer for measuring the source signal spectrum with absolute wavelength information for the application of time-stretch based distance measurement with multiple probes according to embodiments.

### DETAILED DESCRIPTION

The real-time measurement of fast non-repetitive events is arguably the most challenging problem in the field of instrumentation and measurement. These instruments are needed for investigating rapid transient phenomena such as chemical reactions, fast physical phenomena, phase transitions, protein dynamics in living cells and/or impairments in data networks. Optical spectrometers are a basic instrument for performing sensing and detection in chemistry, physics and biology applications. Unfortunately, a scan rate of a spectrometer is often too long compared with the timescale of physical processes of interest. In terms of conventional optical spectroscopy, this temporal mismatch means that an instrument is too slow to perform real-time single-shot spectroscopic measurements. Single-shot measurement tools such as frequency-resolved optical gating (FROG) and spectral phase interferometry for direct electric-field reconstruction (SPIDER) are, although powerful, therefore unable to perform pulse-resolved spectral measurements in real time.

In embodiments, Time-Stretch Dispersive Fourier transformation (TS-DFT) is a powerful method that overcomes the speed limitation of traditional spectrometers and hence enables fast real-time spectroscopic measurements. Using chromatic dispersion otherwise known as group velocity dispersion (GVD), TS-DFT maps a spectrum of an optical pulse to a temporal waveform whose intensity mimics the spectrum, thus allowing a single-pixel photo-detector to capture the spectrum at a scan rate significantly beyond what is possible with conventional space-domain spectrometers. Over the past decade, this method has brought a new class of real-time instruments that permit the capture of rare events such as optical rogue waves and rare cancer cells in blood, which would otherwise be missed or not-detectable using conventional instruments. TS-DFT may be implemented using any kind of optical fiber, dispersion compensating fiber, chirped gratings, free space gratings, prisms, chromo-modal dispersion, multiple ring resonators with different delays, multiple discrete delay lines with different delays, or combinations of these elements, and/or any other optical dispersive element.

In many applications of interest, there exists a need for capturing multiple single-shot events simultaneously. These applications, include, but are not limited to multiple-probe Photonic velocimetry, multiple-probe Photon Doppler velocimetry (PDV), multiple-probe Photonic vibrometry, multiple-probe optical coherence tomography (OCT), multiple-probe optical imaging, multiple-probe Photonic vibrometry, multiple-probe Laser induced breakdown spectroscopy (LIBS), multiple-probe Optical Time Domain Reflectometry (OTDR), and/or multiple-probe LIDAR, etc.

In embodiments, a challenge is that conventional TS-DFT systems may only support one probe per pulse. It is critical for the mentioned applications that systems, method and/or apparatus are developed that allow for capturing real-time and single-shot non-overlapping spectral bands from multiple probes simultaneously.

In embodiments, real-time and single-shot non-overlapping spectral bands may be captured from multiple probes simultaneously. In embodiments, a WDM device may be used to separate different spectral bands of each input pulse and direct separated spectral bands to each of multiple probes. In embodiments, each probe may receive a separate spectral band. When combined with TS-DFT systems and/or a reference signal, information about the different probes may be captured in real-time and single-shot using digital post-processing.

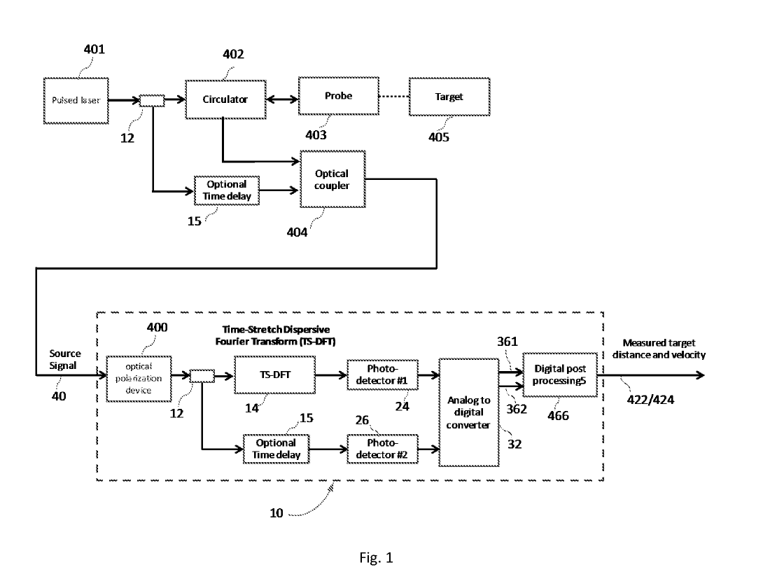

FIG. 1 illustrates a block diagram for an implementation of a time-stretched spectrometer 10 for measuring a source signal spectrum with absolute wavelength information for a time-stretch based distance measurement application. In embodiments, a laser my launch pulsed laser light optical signal 401 into an optical coupler 12. In embodiments, one output of a coupler may be communicated and/or input to a circulator 402. In embodiments, a circulator 402 may output or communicate a signal to a probe 403, which may illuminate a target 405. In embodiments, a reflected optical signal from a target 405 may be communicated back and/or pass through a probe 403 and may circulate back to a third port of a circulator 402. In embodiments, another or second output of an optical coupler 12 may be communicated through and/or pass through an optical time delay 15 and may be combined with a circulator third output port 402 using optical coupler 404. In embodiments, an output of the coupler 404 may pass and/or travel through an optical polarization device 400. In embodiments, an optical polarization device 400 may be a quarter-waveplate, a half-waveplate, a polarizer or any combination of those. In embodiments, a coupler element 12 may divide a source signal 40 power (e.g., an output of an optical polarization device) into two channels (e.g., a main channel and a secondary channel). In embodiments, a main channel pulse may pass and/or travel through a Time-Stretch Dispersive Fourier Transform system 14. In embodiments, a secondary channel pulse may pass and/or travel through an optional time delay element 15. In embodiments, an output of a main channel and a secondary channel may be photo detected separately using photo detector elements 24 and 26. In embodiments, after photo detection, an output of a main channel and a secondary channel may be digitized separately using a multi-channel analog to digital converter element 32. In embodiments, a time delay between a main channel output signal 361 and a secondary channel 362 output signal may be utilized by a digital post processing5 unit 466 to determine and/or calculate a target distance 422 and/or velocity 424.

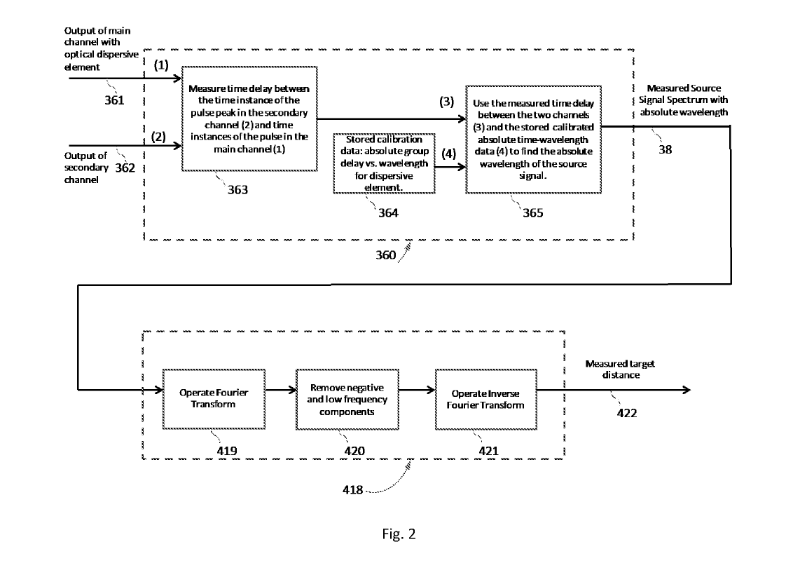

FIG. 2 illustrates a flow chart of an algorithm and/or process utilized by a digital post processing5 unit 466 to retrieve absolute wavelength information of a source signal for a time-stretch based distance measurement application. In embodiments, a time delay between a time instance of a pulse peak in a Secondary Channel (2) (362—FIG. 1) and time instances of a pulse peak in a Main Channel (1) (361—FIG. 1) may be calculated 363 utilizing computer-readable instructions executable by a processor and/or controller. In embodiments, a calculated time delay between the two channels (3) 363 and stored calibration absolute time-wavelength relation digital data (4) 364 may be utilized to find 365 absolute wavelength information of a source signal 38 using computer-readable instructions executable by a processor and/or controller. In embodiments, a spectrum with absolute wavelength 38 undergo Fourier transformation 419 to calculate target distance. In embodiments, negative and low frequency parts of a spectrum may be removed digitally in unit 420 utilizing computer-readable instructions executable by a processor and/or controller. In embodiments, an inverse Fourier transform 421 may be performed on and/or operated on a signal to calculate a target distance 422.

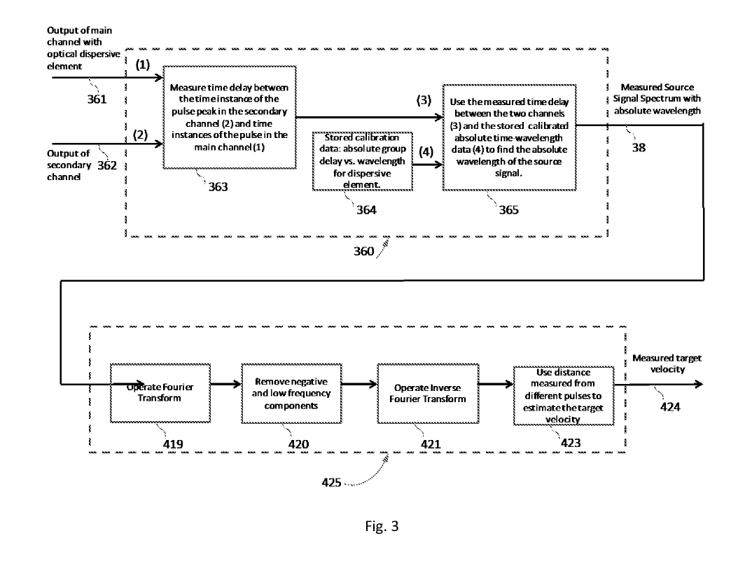

FIG. 3 illustrates a flow chart of the algorithm or process used in digital post processing5 unit 466 to retrieve an absolute wavelength information of a source signal for a time-stretch based distance measurement application of. In embodiments, a time delay between a time instance of a pulse peak in the Secondary Channel (2) (361—FIG. 2) and time instances of a pulse peak in a Main Channel (1) (361—FIG. 1) may be calculated 363 utilizing computer-readable instructions executable by a processor and/or controller. Then, a calculated time delay between the main channel (2) (362) and the secondary channel 361 (1) (3) (363) and a stored calibration absolute time-wavelength relation digital data (4) 364 may be utilized to find 365 an absolute wavelength information of a source signal 38 utilizing computer-readable instructions executable by a processor and/or controller. In embodiments, a spectrum with absolute wavelength 38 may be passed through or may be subject to Fourier transformation process 419. In embodiments, a negative part and a low frequency part of a spectrum may be removed digitally by unit or computing device 420 utilizing computer-readable instructions executable by a processor and/or controller. In embodiments, an inverse Fourier transform 421 may be performed and/or operated on a signal after the negative parts and low frequency parts are removed utilizing computer-readable instructions executable by a processor and/or controller. In embodiments, unit and/or computing device 423 may measure and/or determine a distance between consecutive pulses is used in unit and/or computing device 423 to calculate a target velocity 424.

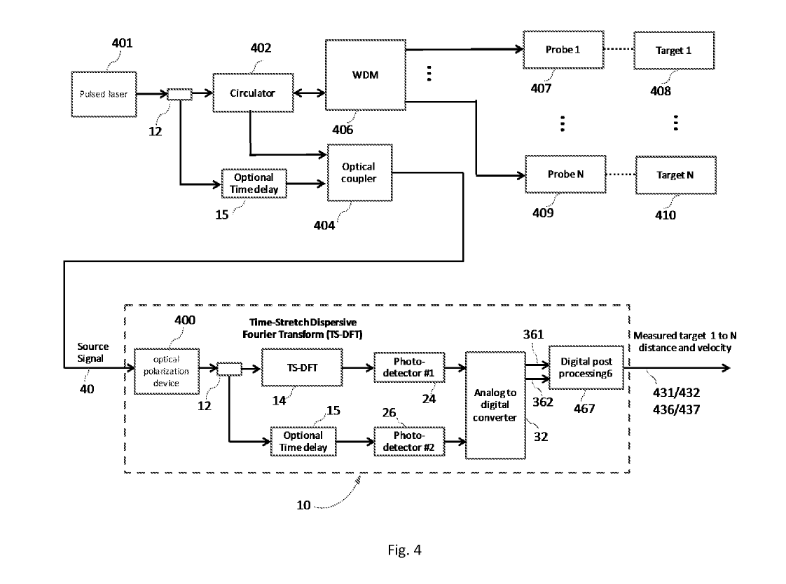

FIG. 4 is a block diagram for an implementation of a time-stretched spectrometer 10 for measuring source signal spectrum with absolute wavelength information for a time-stretch based distance measurement application with multiple probes. In embodiments, a laser 401 may pulse and/or launch laser light 401 into an optical coupler 12. In embodiments, a first output of an optical coupler may be communicated and/or transferred to a circulator 402 and then communicated and transferred to a WDM unit 406. In embodiments, outputs of a WDM unit may be communicated and/or connected to a first probe 407 up to an N probe 409, which may be illuminating respective targets 408 to 410. In embodiments, a number of WDM channels as well as probes can be as few as 1 and/or as high or more than 64. In embodiments, fiber lengths to each probe may be adjusted as to avoid overlapping of channels. In embodiments, reflected optical signals from targets 408 to 410 may be communicated back, reflected back and/or go back to probes 407 to 409 and may be circulated to circulator 402. In embodiments, a second or other output of a coupler may be communicated and/or passed through an optical time delay 15 and may be combined with a circulator third output port using an optical coupler 404. In embodiments, an output of a coupler 404 may be communicated and/or passed through an optical polarization device 400. In embodiments, an optical polarization device 400 may be a quarter-waveplate, a half-waveplate, a polarizer or any combination of those. In embodiments, a coupler element 12 may divide a source signal 40 (e.g., an output of a coupler) power into two channels (e.g., a main channel and/or a secondary channel). In embodiments, a main channel pulse may pass or be communicated through a Time-Stretch Dispersive Fourier Transform (TS-DFT) system 14. In embodiments, a secondary channel pulse may be communicated and/or pass through an optional time delay element 15. In embodiments, an output of a main channel and/or a secondary channel may be photo detected separately using photo detector elements 24 and 26, respectively. In embodiments, photo detector 24 output and photo detector output 26 may be digitized separately using a multi-channel analog to digital converter element 32. In embodiments, a time delay between a main channel output signal 361 and a secondary channel output signal 362 may be calculated and/or determined and may be utilized by digital post processing6 unit 467 to find a target distance 431 and/or velocity 432 as well as and up to a target N distance and/or a target N velocity (e.g., if there are three targets, three distances and/or velocities may be found).

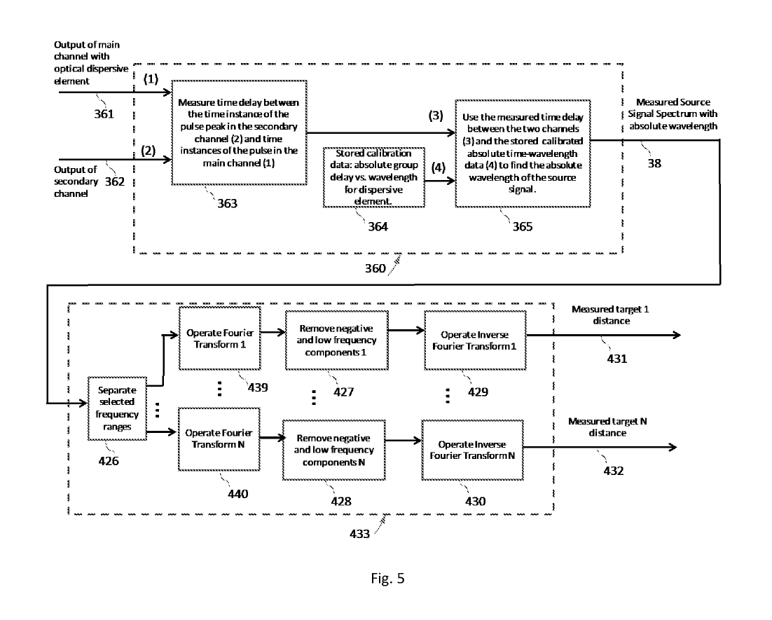

FIG. 5 illustrates a flow chart of the algorithm or process used in digital post processing6 unit 467 to retrieve an absolute wavelength information of a source signal for times with multiple probes. In embodiments, a time delay between a time instance of a pulse peak in a secondary channel (2) 362 and time instances of a pulse peak in a main channel (1) 361 may be calculated 363 by computer-readable instructions executable by a processor or controller. In embodiments, a calculated time delay between the two channels (3) 363 and stored calibration absolute time-wavelength relation digital data (4) 364 may be utilized to find and/or determine absolute wavelength information of a source signal 38 utilizing computer-readable instructions executable by a processor and/or controller. In embodiments, to calculate a target's distances, a spectrum with absolute wavelength 38 may be divided to selected frequency ranges using algorithm unit 426 (or computing device 426) and then each output may be communicated through and/or passed through Fourier transformation 439 to 440. In embodiments, negative and low frequency parts of a spectrum may be removed digitally in algorithm unit and/or computing device 427 to 428. In embodiments, a signal with negative and low frequency parts removed may be subject to and/or operated on by an inverse Fourier transform 429 to 430 to calculate a target 1 distance 431 up to and including target N distance 432 (e.g., if there are three targets, three distances and/or velocities may be found).

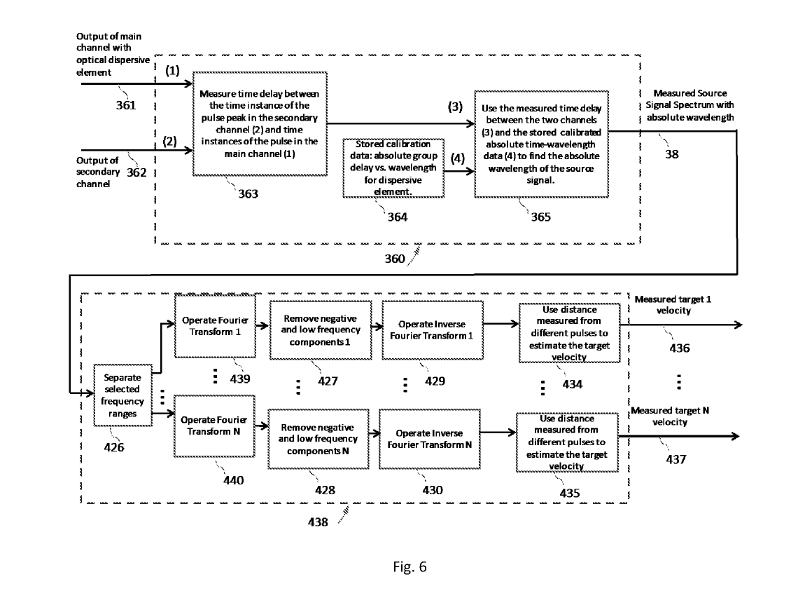

FIG. 6 illustrates a flow chart of an algorithm or process used or utilized by digital post processing6 unit 467 to retrieve an absolute wavelength information of a source signal for a time-stretch based velocity measurement application of with multiple probes. In embodiments, a time delay between a time instance of a pulse peak in a secondary channel (2) 62 and time instances of a pulse peak in Main Channel (1) 361 may be calculated and/or determined 363 utilizing computer-readable instructions executable by a processor and/or controller. In embodiments, a calculated time delay between the two channels (3) 363 and stored calibration absolute time-wavelength relation digital data (4) 364 may be utilized in 365 to find absolute wavelength information of a source signal 38 utilizing computer-readable instructions executable by a processor and/or controller. In embodiments, to calculate a target's velocities, a spectrum with absolute wavelength 38 may be divided into selected frequency ranges using algorithm unit or computing device 426 and then each output may be passed and/or communicated through Fourier transformation 439 to 440. In embodiments, negative and low frequency parts of a spectrum may be removed digitally in algorithm unit (or computing device) 427 to 428. In embodiments, a spectrum signal may be subject to be operated on by an inverse Fourier transform 429 to 430 to calculate a target's distances. In embodiments, an algorithm unit (or computing device) 434 may calculate 435 target 1 velocity 436 including and/or up to target N velocity 437 (e.g., if there are three targets, three distances and/or velocities may be found) by measuring a target distance between consecutive pulses.

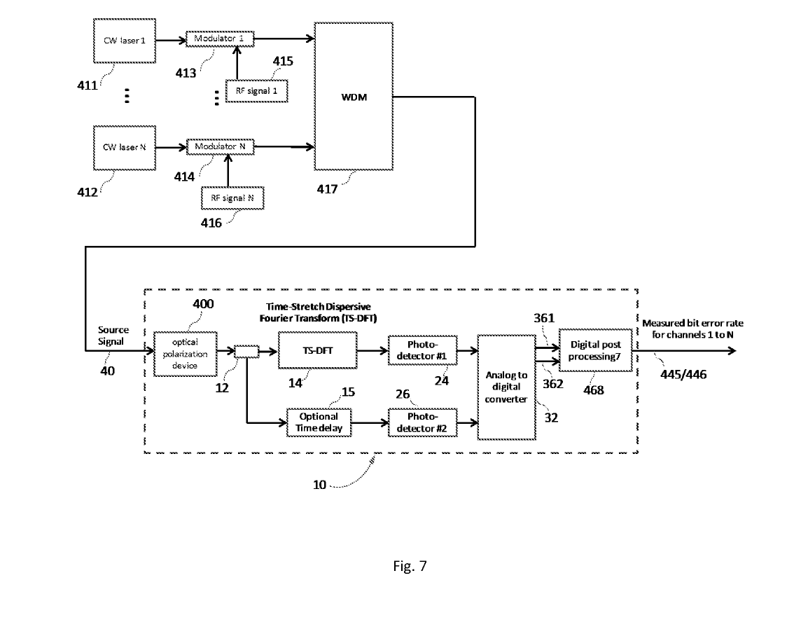

FIG. 7 illustrates a block diagram for an implementation of a time-stretched spectrometer 10 for measuring a source signal spectrum with absolute wavelength information for a bit error rate measurement in multi-channel optical communications application. In embodiments, N (or multiple) continuous wave (CW) lasers 411 to 412 may be launched and/or input into optical modulator units 413 to 414. In embodiments, each optical modulator may modulate the input CW light with an optical communication RF signal 415 to 416. In embodiments, outputs of modulators 413 and 414 may be combined using a WDM unit 417. In embodiments, an output of a WDM unit may pass through or be communicated through an optical polarization device 400. In embodiments, an optical polarization device 400 may be a quarter-waveplate, a half-waveplate, a polarizer or any combination of those. In embodiments, a coupler element 12 may be used to divide a source signal 40 power (e.g., source signal may be an output of an optical polarization device) into two channels (e.g., a main channel and a secondary channel). In embodiments, a main channel pulse may pass through or be communicated through a Time-Stretch Dispersive Fourier Transform (TS-DFT) system 14 and in a secondary channel pulse may pass through or be communicated through an optional time delay element 15. In embodiments, pulses of output signals of each channel (e.g., a main channel optical output pulses and secondary channel output pulses) may be photo detected separately using photo detector elements 24 and 26, respectively. In embodiments, outputs of photo detector elements 24 and 26 may be digitized separately using a multi-channel analog to digital converter element 32. In embodiments, a time delay between the two channels (e.g., main channel output signals 361 and secondary channel output signals 362) followed by digital processing may be utilized in digital post processing7 unit 468 to find, calculate and/or determine a bit error rate in an optical communication system 445 446.

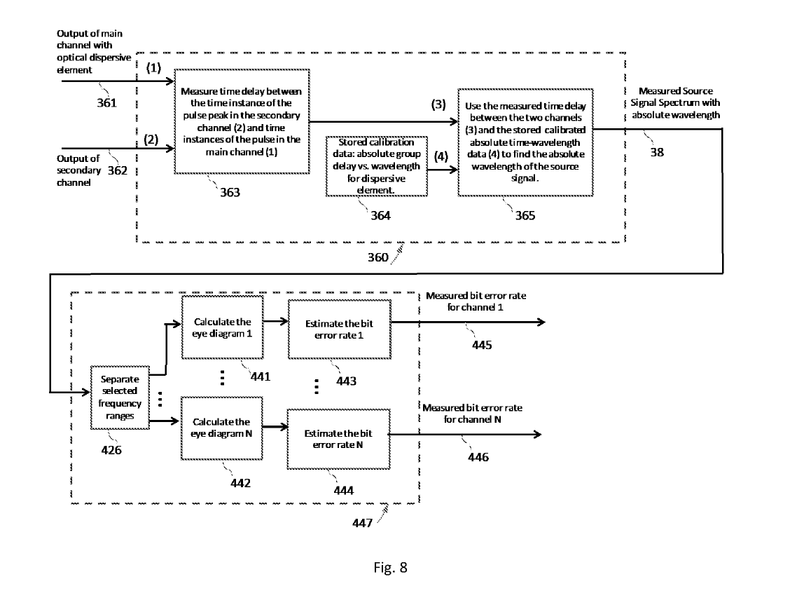

FIG. 8 illustrates a flow chart of an algorithm and/or process utilized in digital post processing7 unit 468 to retrieve absolute wavelength information of a source signal for a bit error rate measurement in multi-channel optical communications application of. In embodiments, a time delay between a time instance of a pulse peak in a secondary channel (2) (362) and time instances of a pulse peak in a main channel (1) (361) may be calculated 363 utilizing computer-readable instructions executable by a processor or controller. In embodiments, a calculated time delay between the two channels (3) and a stored calibration absolute time-wavelength relation digital data (4) 364 may be utilized in 365 to find, calculate and/or determine absolute wavelength information of a source signal 38 utilizing computer-readable instructions executable by a processor and/or controller. To calculate a bit error rate for each channel, a spectrum with absolute wavelength 38 may be divided to selected frequency ranges using algorithm unit and/or computing device 426. In embodiments, an eye diagram may be calculated for each channel in algorithm units and/or computing device 441 to 442. In embodiments, a bit error rate for channel 1 445 to channel N 446 may be estimated and/or determined in algorithm units and/or computing devices 443 to 444.

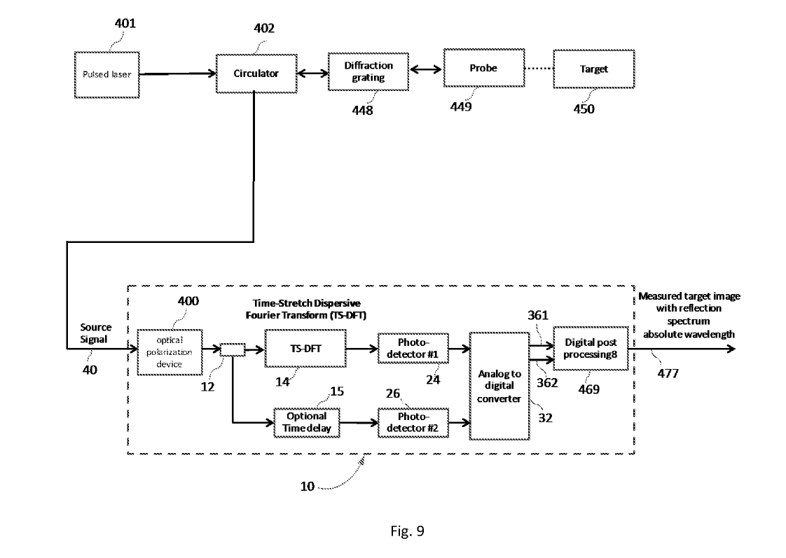

FIG. 9 illustrates a block diagram for an implementation of a time-stretched spectrometer 10 for measuring a source signal spectrum with absolute wavelength information for a time-stretch imaging application of. In embodiments, a pulsed laser 401 may be launched and/or emitted into a circulator 402. In embodiments, a second port of a circulator may be connected and/or coupled to a diffraction grating 448. In embodiments, a diffraction grating 448 may be coupled and/or connected to a probe 449 which may illuminate a target 450. In embodiments, reflected optical signals from a target 450 may be reflected back and/or communicated back or go back to probes 449 through diffraction grating 338 and may be circulated to a third port of a circulator 402. In embodiments, a signal from a third port of a circulator 402 may pass through and/or be communicated through an optical polarization device 400. In embodiments, an optical polarization device 400 may be a quarter-waveplate, a half-waveplate, a polarizer or any combination of those. In embodiments, a coupler element 12 may be used to divide a source signal 40 power (e.g., an output from an optical polarization device 400) into two channels (e.g., a main channel and a secondary channel). In embodiments, main channel optical pulses may pass through or may be communicated through a Time-Stretch Dispersive Fourier Transform (TS-DFT) system 14 and a secondary channel optical pulses may pass through and/or be communicated through an optional time delay element 15. In embodiments, output signals of each channel (e.g., main channel output signals and secondary channel output signals) may be photo detected separately using photo detector elements 24 and 26, respectively. In embodiments, outputs of photo detector elements 24 and 26 may be digitized separately using a multi-channel analog to digital converter element 32. In embodiments, a time delay between two channel output signals (e.g., main channel output signals and secondary channel output signals) followed by digital processing (performed in digital post processing8 unit 469) to obtain target images and also a reflection spectrum with absolute wavelength 477. In embodiments, capturing of target images may be possible since diffraction grating allows illumination of a target in two dimensions (2D).

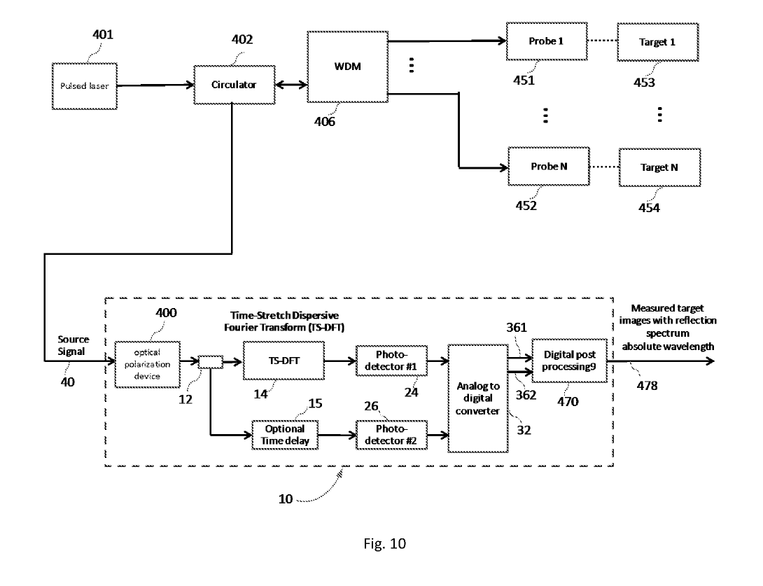

FIG. 10 illustrates a block diagram for an implementation of a time-stretched spectrometer 10 for measuring a source signal spectrum with absolute wavelength information for time-stretch imaging with multiple probes application of. In embodiments, a laser 401 may emit and/or launch a pulsed laser into a circulator 402. In embodiments, a second port of a circulator 402 may be connected and/or coupled to a WDM unit 406. In embodiments, a WDM unit may have N outputs connected to probes 451 to 452 that illuminates targets 453 to 454 via free space. In embodiments, a target may reflect optical signals goes back, may be reflected back, and/or be communicated back to probes 451 to 452, then through WDM 406 and may be circulated through a third port of a circulator 402. In embodiments, a signal from a third port of the circulator 402 (e.g., output signal) may pass through and/or be communicated through an optical polarization device 400. In embodiments, an optical polarization device 400 may be a quarter-waveplate, a half-waveplate, a polarizer or any combination of those. In embodiments, a coupler element 12 may be used to divide a source signal 40 (e.g., an output signal of an optical polarization device (400) power into two channels (e.g., a main channel and/or a secondary channel). In embodiments, main channel optical pulses may pass through and/or be communicated through a Time-Stretch Dispersive Fourier Transform system 14 and secondary channel optical pulses may pass through or be communicated through an optional time delay element 15. In embodiments, output signals of each channel (e.g., main channel output signals and/or secondary channel output signals) may be photo detected separately using photo detector elements 24 and 26 and may be digitized separately using a multi-channel analog to digital converter element 32. In embodiments, a time delay between the two channels (e.g., main channel output signals 361 and/or secondary channel output signals 362) may be digital processed utilizing digital post processing9 unit 469 to measure and/or obtain targets images and also reflection spectrums with absolute wavelength 478.

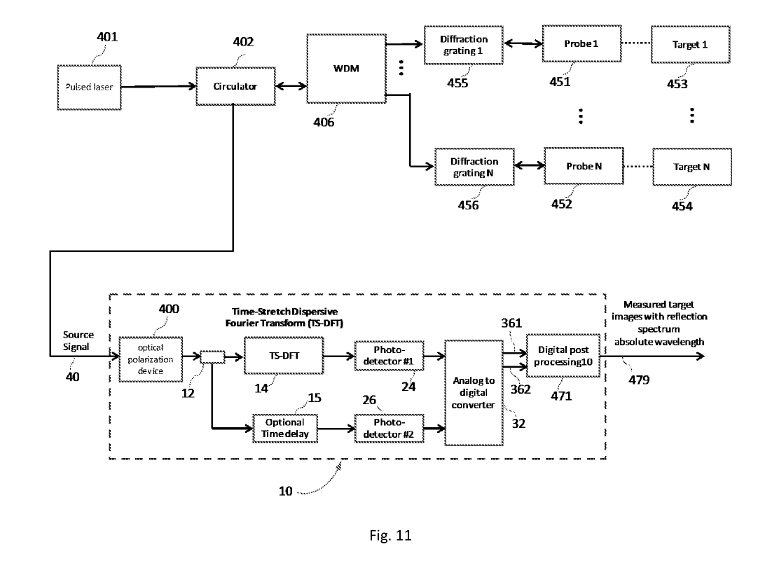

FIG. 11 illustrates a block diagram for an implementation of a time-stretched spectrometer 10 for measuring a source signal spectrum with absolute wavelength information for a time-stretch imaging with multiple probes application of. In embodiments, a laser may emit and/or launch a pulsed laser 401 into a circulator 402. In embodiments, a second port of a circulator may connected to a diffraction grating 448 and/or a diffraction grating 448 which may be connected to a WDM unit 406. In embodiments, a WDM unit 406 may have N outputs which may be connected to N diffraction gratings 455 to 456, respectively. In embodiments, N diffraction gratings may be connected to probes 451 to 452 and probes 451 to 452 may illuminate targets 453 to 454 via free space. In embodiments, reflected optical signals from targets 453 to 454 may be communicated through, pass through and/or go through WDM 406 and may be communicated to and/or circulate to a third port of a circulator 402. In embodiments, a signal from the third port of the circulator 402 (e.g., an output signal) may pass through and/or be communicated through an optical polarization device 400. In embodiments, an optical polarization device 400 may be a quarter-waveplate, a half-waveplate, a polarizer or any combination of those. In embodiments, a coupler element 12 may be used to divide a source signal 40 power (e.g., an output of an optical polarization device 400) into two channels (e.g., a main channel and/or a secondary channel). In embodiments, main channel output pulses may pass through Time-Stretch Dispersive Fourier Transform system 14 and secondary channel output pulses may pass through an optional time delay element 15. In embodiments, an output of each channel (e.g., a main channel and a secondary channel) may be photo detected separately using photo detector elements 24 and 26, respectively. In embodiments, an output from photo detector elements 24 and 26 may be digitized separately using a multi-channel analog to digital converter element 32. In embodiments, a time delay between the two channels output signals (e.g., main channel output signals 361 and secondary channel output signals 362) may be digital processed utilizing digital post processing9 unit 471 to measure targets images and also reflection spectrums with absolute wavelength 479.

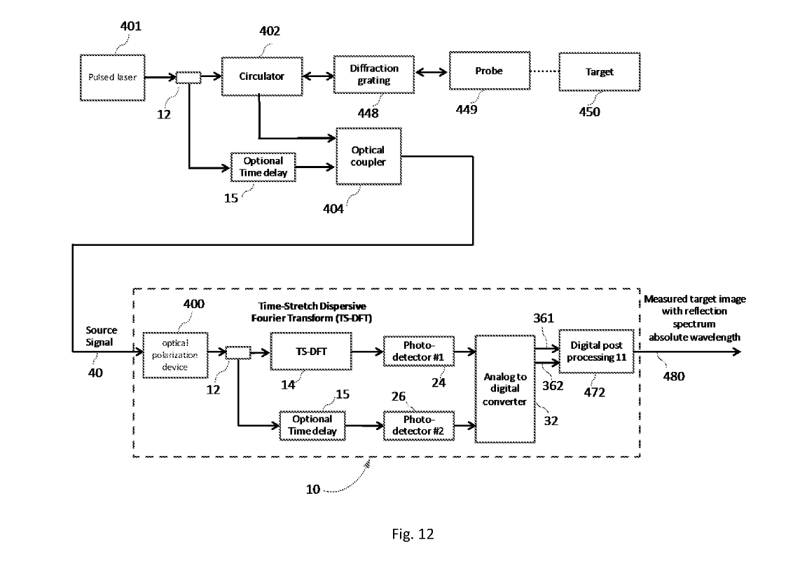

FIG. 12 illustrates a block diagram for an implementation of a time-stretched spectrometer 10 for measuring a source signal spectrum with absolute wavelength information for a coherent time-stretch imaging application. In embodiments, a pulsed laser may emit and/or launch a pulsed laser 401 into a coupler 12. In embodiments, one output or a first output of a coupler may be connected to a circulator 402. In embodiments, a second port of a circulator 402 may be connected to a diffraction grating 448. In embodiments, a diffraction grating 448 may be connected to a probe 449 and a probe may illuminates a target 450. In embodiments, reflected optical signals from a target 450 may be probes 449 then through diffraction grating 448 and may be passed through, be communicated through and/or circulate through a third port of a circulator 402. In embodiments, another output (and/or a second output) of a coupler 12 may be connected to an optical time delay unit 15. In embodiments, a third port of the circulator 402 (e.g., an output signal) and may be combined with an output of a time delay unit may in an optical coupler 404. In embodiments, an output signal of a coupler 404 may pass through and/or be communicated through an optical polarization device 400. In embodiments, an optical polarization device 400 may be a quarter-waveplate, a half-waveplate, a polarizer or any combination of those. In embodiments, a coupler element 12 may be utilized to divide a source signal 40 power (e.g., an output of an optical polarization device 400) into two channels (e.g., a main channel and a secondary channel). In embodiments, a main channel pulse may pass through and/or be communicated through a Time-Stretch Dispersive Fourier Transform system 14 and a secondary channel pulse may pass through and/or be communicated through an optional time delay element 15. In embodiments, output signals of each channel (e.g., main channel output signals and/or secondary channel output signals) may be photo detected separately using photo detector elements 24 and 26. In embodiments, an output of photo detector elements 24 and 26 may be digitized separately using a multi-channel analog to digital converter element 32. In embodiments, a time delay between the two channel's output signals (e.g., main channel output signals 361 and/or secondary channel output signals 362 may be digitally processed utilizing digital post processing11 unit 472 to measure target a complex-amplitude image and also a reflection spectrum with absolute wavelength 480.

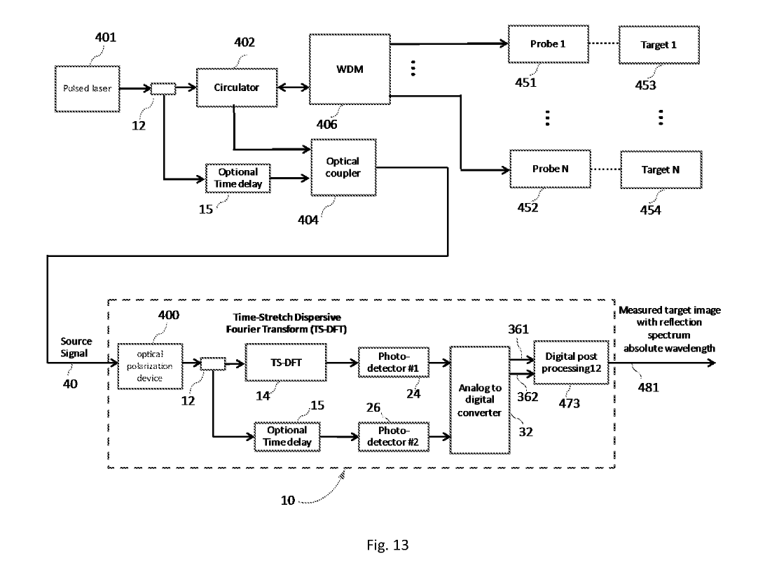

FIG. 13 illustrates a block diagram for an implementation of a time-stretched spectrometer 10 for measuring a source signal spectrum with absolute wavelength information for a coherent time-stretch imaging with multiple probes application. In embodiments, a pulsed laser may be emitted and/or launched by a pulsed laser 401 into a coupler 12. In embodiments, one output (or a first output) of the coupler 12 may be connected to a circulator 402. In embodiments, a second port of a circulator 402 may be connected to a WDM unit 406. In embodiments, a WDM unit 406 whose outputs may be connected to probes 451 to 452 that illuminates targets 453 to 454. In embodiments, reflected optical signals from a target 453 through 454 may be communicated through, pass through and/or go through probes 451 to 452 and then through WDM 406. In embodiments, outputs from WDM 406 may be passed through and circulated to a third port of a circulator 402. In embodiments, another output (a second output) of a coupler 12 may be connected to an optical time delay unit 15. In embodiments, a third port of a circulator 402 (an output signal) may be combined with an output of a time delay unit 15 at an optical coupler 404. In embodiments, an output signal from a coupler 404 may pass through an optical polarization device 400. In embodiments, an optical polarization device 400 may be a quarter-waveplate, a half-waveplate, a polarizer or any combination of those. In embodiments, a coupler element 12 may be used to divide a source signal 40 power (e.g., an output of optical polarization device 400) into two channels. In embodiments, main channel optical pulses may pass through and/or be communicated through a Time-Stretch Dispersive Fourier Transform system 14 and secondary channel optical pulses may pass through and/or be communicated through an optional time delay element 15. In embodiments, an output of each channel (e.g., a main channel and/or a secondary channel) may be photo detected separately using photo detector elements 24 and 26, respectively. In embodiments, output of photo detector elements 24 and 26 may be digitized separately using a multi-channel analog to digital converter element 32. In embodiments, a time delay between the two channel's output signals (e.g., main channel output signals 361 and secondary channel output signals 362) may be digitally processed in a digital post processing12 unit 473 to obtain and/or measure targets images and also reflection spectrums with absolute wavelength 481.

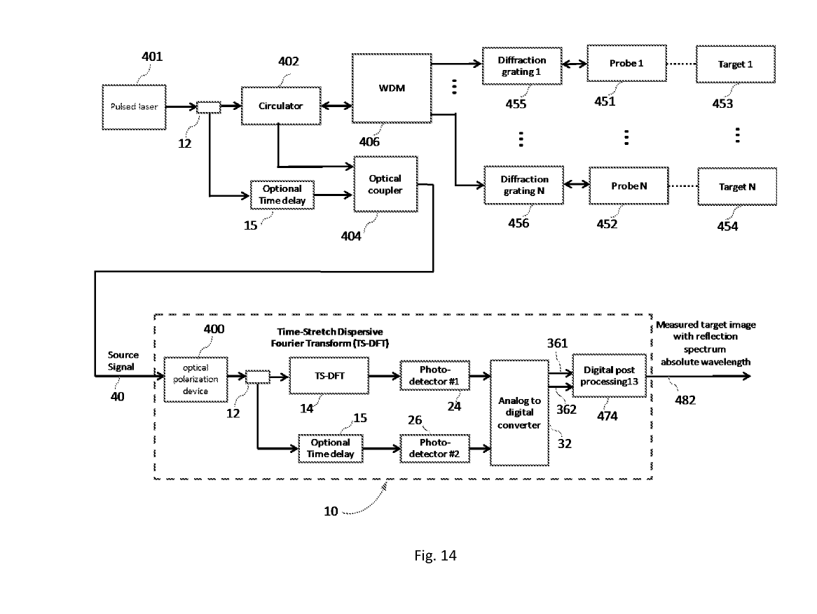

FIG. 14 illustrates a block diagram for an implementation of a time-stretched spectrometer 10 for measuring a source signal spectrum with absolute wavelength information for a coherent time-stretch imaging with multiple probes application. In embodiments, a pulsed laser may emit and/or launch a pulsed laser 401 into a coupler 12. In embodiments, one output of a coupler (e.g., a first output) may be connected to a circulator 402. In embodiments, a second port of a circulator 402 may be connected to a WDM unit 406. In embodiments, WDM unit outputs 406 may be connected to multiple diffraction gratings 455 to 456. In embodiments, multiple diffraction gratings 455 to 456 may be connected to probes 451 to 452 and probes 451 to 452 may illuminate targets 453 to 454. In embodiments, reflected optical signals from a target 453 through 454 may be communicated through, pass through and/or go through probes 451 to 452 and then through WDM 406. In embodiments, outputs from WDM 406 may be passed through and circulated to a third port of a circulator 402. In embodiments, another output (e.g., a second output) of a coupler 12 may be connected to an optical time delay unit 15. In embodiments, a third port of the circulator 402 may be combined with an output of the time delay unit 15 at a or via an optical coupler 404. In embodiments, an output signal of the coupler 404 may pass through and/or be communicated through an optical polarization device 400. In embodiments, an optical polarization device 400 may be a quarter-waveplate, a half-waveplate, a polarizer or any combination of those. In embodiments, a coupler element 12 may be used to divide a source signal 40 power (e.g., an output of an optical polarization device into two channels (e.g., a main channel and/or a secondary channel). In embodiments, main channel optical pulses may pass through and/or be communicated through a Time-Stretch Dispersive Fourier Transform system 14 and secondary channel optical pulses may pass through and/or be communicated through an optional time delay element 15. In embodiments, an output of each channel (e.g., main channel output signals and secondary channel output signals) may be photo detected separately using photo detector elements 24 and 26. In embodiments, outputs of photo detector elements 24 and 26 may be digitized separately using a multi-channel analog to digital converter element 32. In embodiments, a time delay between the two channels (e.g., main channel optical signals 361 and secondary channel optical signals 362) may be utilized by a digital post processing13 unit 474 to measure and/or obtain targets images and/or also reflection spectrums with absolute wavelength 482.

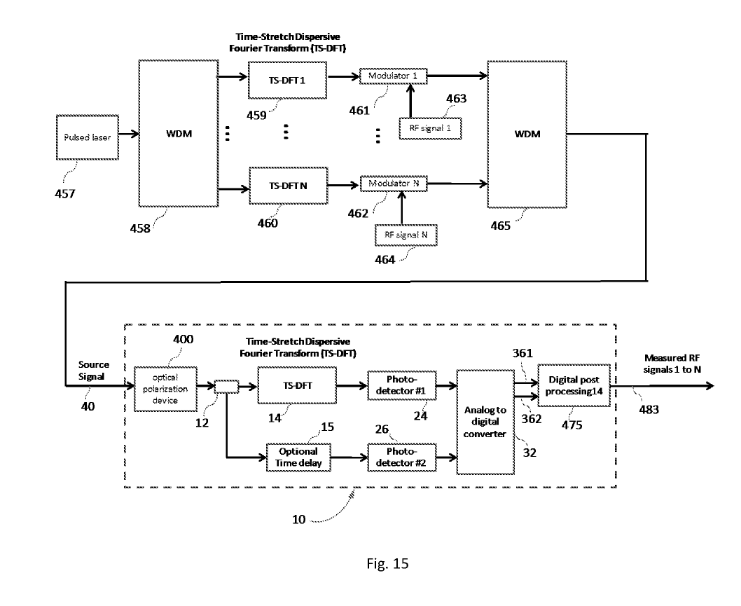

FIG. 15 illustrates a block diagram for an implementation of a time-stretched spectrometer 10 for measuring a source signal spectrum with absolute wavelength information for a time-stretch digitizer with multiple input RF channels application. In embodiments, a laser may emit and/or launch a pulsed laser 457 into a WDM unit 458. In embodiments, a WDM unit 458, whose outputs may be connected and/or coupled to multiple TS-DFT units 459 to 460. In embodiments, multiple TS-DFT units 459 to 460 may be connected and/or coupled to modulators 461 to 462, where input signals may be modulated by RF signal 1 unit 463 to RF signal N unit 464. In embodiments, modulated signals output from modulators 461 to 462 may be recombined using WDM unit 465. In embodiments, signal(s) output from a WDM 465 may pass through and be communicated through an optical polarization device 400. In embodiments, an optical polarization device 400 may be a quarter-waveplate, a half-waveplate, a polarizer or any combination of those. In embodiments, a coupler element 12 may be used to divide a source signal 40 power (e.g., a signal output from an optical polarization device into two channels (e.g., a main channel and a secondary channel). In embodiments, main channel optical pulses may pass through or be communicated through Time-Stretch Dispersive Fourier Transform system 14 and secondary channel optical pulses may pass through and/or be communicated through an optional time delay element 15. In embodiments, an output of each channel (e.g., main channel output signals and secondary channel output signals) may be photo detected separately using photo detector elements 24 and 26. In embodiments, signals output from photo detector elements 24 and 26 may be digitized separately using a multi-channel analog to digital converter element 32. In embodiments, a time delay between the two channels (e.g., main channel output signals 361 and secondary channel output signals 362) may be utilized in digital post processing14 unit 475 to measure and/or determine RF signals from multiple channels 463 and 464 and also the reflection spectrums with absolute wavelength 484.

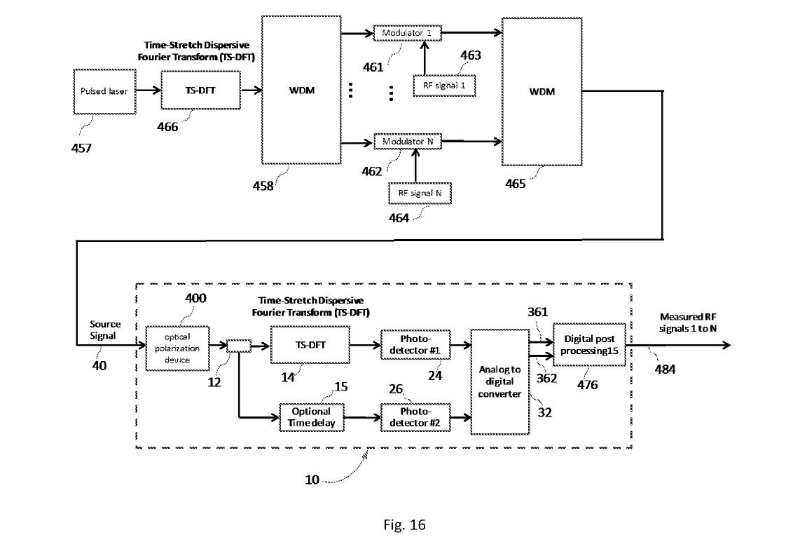

FIG. 16 illustrates a block diagram for an implementation of a time-stretched spectrometer 10 for measuring a source signal spectrum with absolute wavelength information for a time-stretch digitizer with multiple input RF channels application. In embodiments, a pulsed laser may emit and/or launch a pulsed laser 457 into a TS-DFT unit 466. In embodiments, a TS-DFT unit 466, which may be connected and/or coupled to a WDM unit 458. In embodiments, outputs of a WDM unit 458 may be connected and/or coupled to multiple modulators 461 to 462 which are modulated by RF signals 1 unit 463 to RF signal N unit 464. In embodiments, signals output by modulators 461 to 462 may be recombined using WDM unit 465. In embodiments, signals output from a WDM 465 may pass through and/or be communicated through an optical polarization device 400. In embodiments, an optical polarization device 400 may be a quarter-waveplate, a half-waveplate, a polarizer or any combination of those. In embodiments, a coupler element 12 may be used to divide the source signal 40 power (e.g., a signal output from an optical polarization device 400) into two channels (e.g., a main channel and a secondary channel). In embodiments, main channel optical pulses may pass through or be communicated through Time-Stretch Dispersive Fourier Transform system 14 and secondary channel optical pulses may pass through or be communicated through an optional time delay element 15. In embodiments, an output of each channel (e.g., main channel output signal 361 and secondary channel output signal) may be photo detected separately using photo detector elements 24 and 26. In embodiments, signals output from photo detector elements 24 and 26 may be digitized separately using a multi-channel analog to digital converter element 32. In embodiments, a time delay between the two channels (e.g., main channel output signal and secondary channel output signal) may be utilized by a digital post processing15 unit 476 to measure RF signals from multiple channels and also reflection spectrums with absolute wavelength 484.

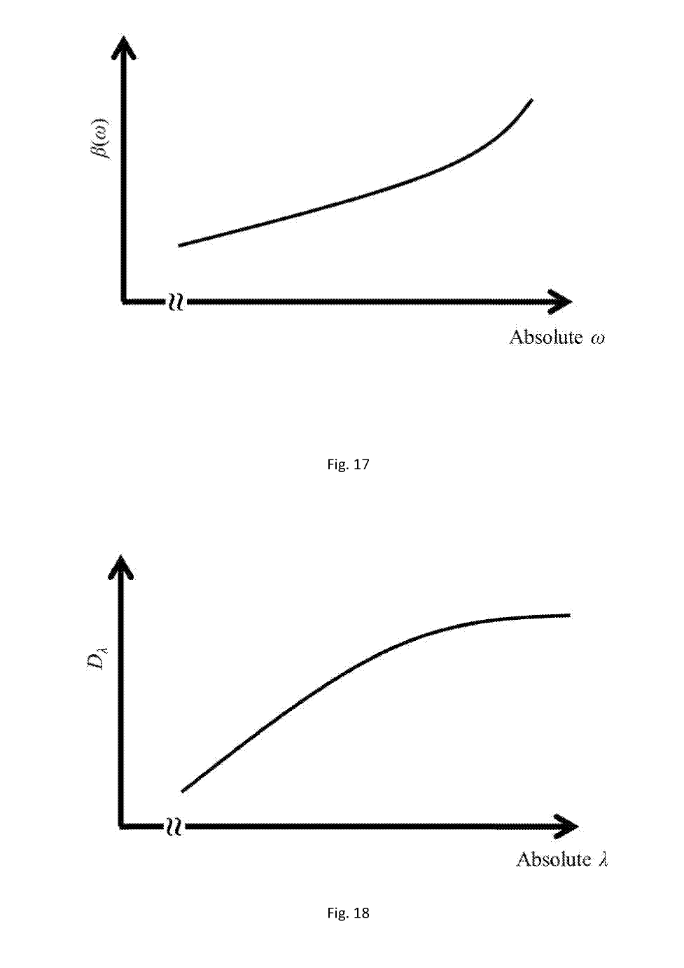

FIG. 17 illustrates an example of β(ω) profile as a function of absolute frequency. In a proposed method and/or process a relation of β(ω) versus absolute frequency may be used to find a source signal absolute frequency and/or wavelength information.

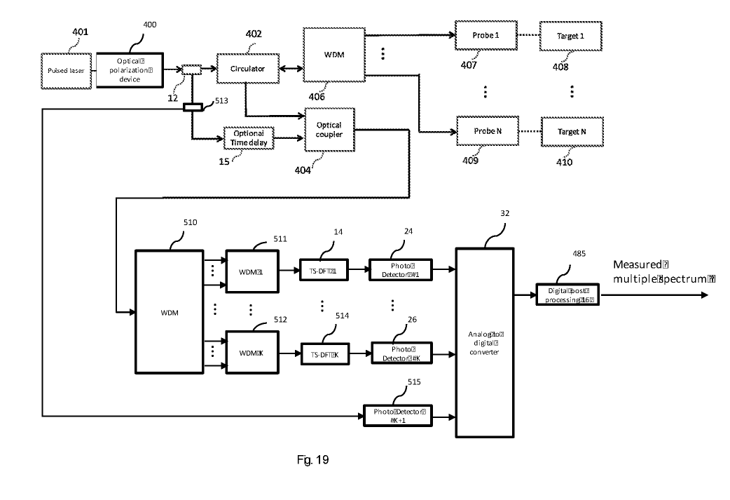

FIG. 18 illustrates an example dispersion factor (Dλ) profile as a function of absolute wavelength variable. In a proposed method and/or process, a relation of D_{λ} to absolute wavelength may also be used to find a source signal absolute frequency and/or wavelength information.

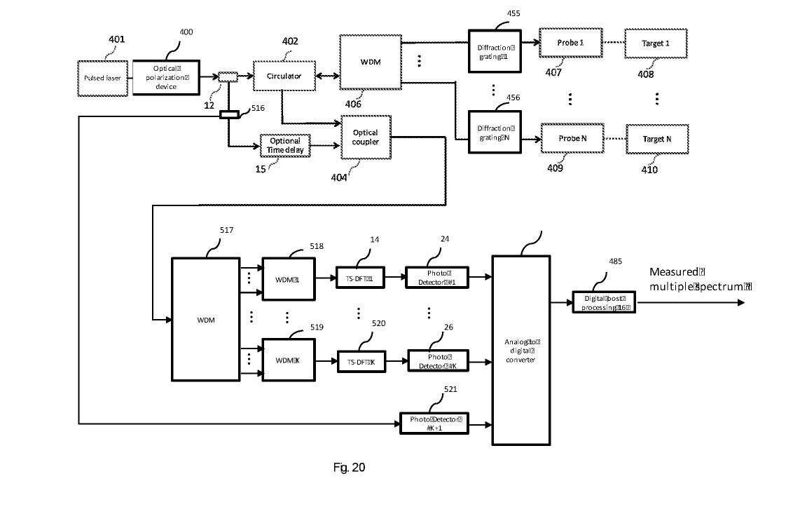

FIG. 19 illustrates lock diagram for an implementation of a time-stretched spectrometer 10 for measuring a source signal spectrum with absolute wavelength information for a time-stretched based distance measurement with multiple probes application. In embodiments, a pulsed laser may emit and/or launch a pulsed laser light 401 through an optical polarization device 400 and then an output laser signals may be emitted and/or launched into an optical coupler 12. In embodiments, ne (or a first) output of a coupler may pass through or be communicated through a circulator 402 followed by a WDM unit 406. In embodiments, outputs of a WDM unit 406 may be connected and/or coupled to N probes 407 to 409, which may illuminate targets 408 to 410. In embodiments, reflected optical signals from targets 408 to 410 may be communicated through, pass through and/or reflected through probes 407 to 409 and then through WDM 406. In embodiments, outputs from WDM 406 may be passed through and circulated to a third port of a circulator 402. In embodiments, an other output (or second output) of a coupler may pass through or be communicated through another coupler 513. In embodiments, one output of an another coupler 513 passes through and/or may be communicated through photodetector k+1 and an other output of the coupler 12 passes through and/or may be communicated through an optical time delay 15. In embodiments, outputs of a time delay 15 and a circulator 402 may be combined using optical coupler 404. In embodiments, an output of a coupler 404 may pass through and/or be communicated to a WDM unit 406 with M outputs which are connected to K WDM units 406 to 406. In embodiments, each output of K WDM units may pass through or be subject to a Time-Stretch Dispersive Fourier Transform system 14 with optional EDFA or Raman amplifiers. In embodiments, an output signal of each channel (e.g., main channel output signal and secondary channel output signal) may be photo detected separately using photo detector elements 24 to 26. In embodiments, signals output from photo detector elements 24 to 26 may be digitized separately using a multi-channel analog to digital converter element 32. In embodiments, digital post processing 16 in unit 485 may be utilized to obtain and/or calculate multiple spectrums from captured by N probes and then computer-readable instructions executable by a processor and/or controller may calculate distance of target 408 to 410.

FIG. 20 illustrates a block diagram for an implementation of a time-stretched spectrometer 10 for measuring a source signal spectrum with absolute wavelength information for a time-stretch based distance measurement with multiple probes application. In embodiments, a pulsed laser may emit and/or launch a pulsed laser 401 through an optical polarization device 400. In embodiments, polarized laser light may be emitted and/or may be launched into an optical coupler 12. In embodiments, one output (or a first output) of a coupler 12 may pass through and/or be communicated to a circulator 402 followed by a WDM unit 406. In embodiments, outputs of the WDM unit 406 may be connected and/or coupled to N diffraction gratings 455 to 456. In embodiments, N diffraction gratings 455 to 456 may be connected to N probes 407 to 409, which may illuminate targets 408 to 410. In embodiments, reflected optical signals from targets 408 to 410 may be communicated through, pass through and/or reflected through probes 407 to 409 and then through WDM 406. In embodiments, outputs from WDM 406 may be passed through and circulated to a third port of a circulator 402. In embodiments, an other output (or second output) of a coupler may pass through or be communicated through another coupler 516. In embodiments, one output of another coupler 516 may pass through and/or be communicated through a photodetector k+1 521 and an other output of another coupler 516 may pass through and/or be communicated through an optical time delay 15. In embodiments, outputs of a time delay 15 and a circulator 402 may be recombined using optical coupler 404. In embodiments, an output of the coupler 404 may pass through and/or be communicated through a WDM unit 517 with M outputs which are connected to K WDM units 518 to 519. In embodiments, each output of K WDM units may pass through and/or be communicated through Time-Stretch Dispersive Fourier Transform system 14 through 520 with optional EDFA and/or Raman amplifier. In embodiments, an output signal of each channel may be (e.g., main channel output signal and secondary channel output signal) photo detected separately using photo detector elements 24 to 26. In embodiments, signals output from photo detector elements 24 to 26 may be digitized separately using a multi-channel analog to digital converter element 32. In embodiments, digital post processing 16 in unit 485 may be utilized to obtain and/or calculate multiple spectrums from captured by N probes and calculate distance of target 408 to and/or through 410.

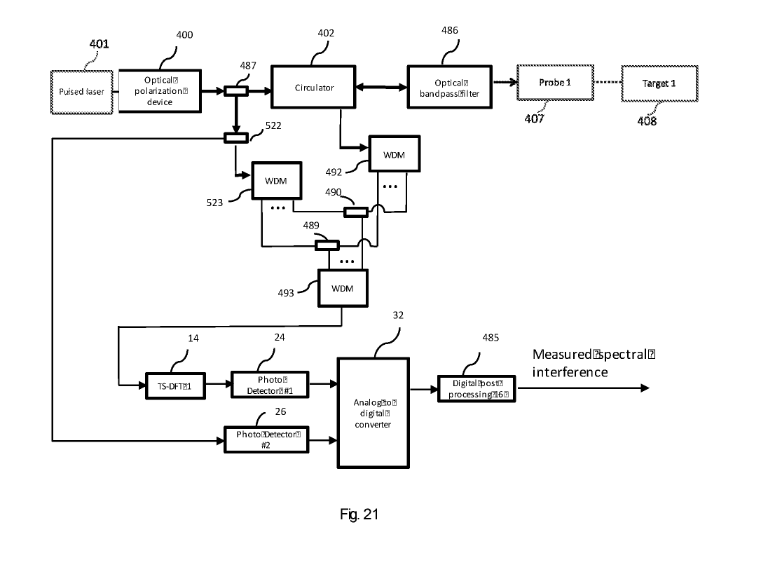

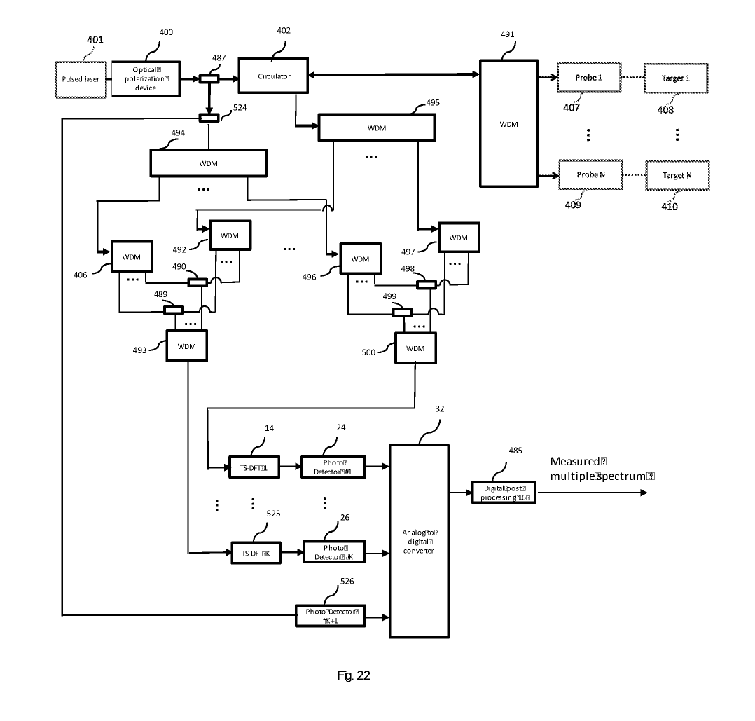

FIG. 21 illustrates a block diagram for an implementation of a time-stretched spectrometer 10 for measuring a source signal spectrum with absolute wavelength information for a time-stretch based distance measurement application. In embodiments, a pulsed laser may emit and/or launch pulsed laser light 401 through an optical polarization device 400. In embodiments, polarized laser light may be launched into an optical coupler 487. In embodiments, one output (a first output) of the coupler 487 may be communicated to and/or pass through) a circulator 402 and/or an optical bandpass filter unit 486. In embodiments, an output of an optical bandpass filter unit 486 may be connected and/or coupled to probe 1 unit 407 which illuminates target 1 unit or device 408. In embodiments, reflected optical signals from target 408 may be communicated through, pass through and/or go back through probe 407 and then through WDM 406. In embodiments, outputs from WDM 406 may be passed through and circulated to a third port of a circulator 402. In embodiments, an other (e.g., a second output) of the coupler may pass through and/or be communicated to another coupler 12. In embodiments, one output of the coupler may pass through and/or be communicated to photodetector 2 26 and the other output of the coupler may pass through and/or be communicated to a WDM unit 406. In embodiments, a third port output of the circulator 402 may pass through and/or be communicated to WDM unit 492. In embodiments, an output of the WDM unit 406 may be combined with corresponding output of the WDM units 492 using optical coupler 489 through or to 490. In embodiments, the outputs from coupler 489 through 490 are recombined through WDM unit 493. It is noted that the path length through WDM 532 channels and path length through WDM 492 channels can be adjusted to allow specific timing of optical pulses. In embodiments, an output of WDM unit 493 may pass through and/or be communicated to a Time-Stretch Dispersive Fourier Transform system 14 with an optional EDFA or Raman amplifier. In embodiments, an output of a TSDFT system may be photo detected using photo detector element 24. In embodiments, an output of a photo detector element may be digitized using a multi-channel analog to digital converter element 32. In embodiments, a digital post processing 16 in unit or computing device 485 to calculate and/or determine distance of and/or to target.

FIG. 22 illustrates a block diagram for an implementation of a time-stretched spectrometer 10 for measuring a source signal spectrum with absolute wavelength information for a time-stretch based distance measurement with multiple probes application. In embodiments, a laser may emit and/or launch a pulse laser light 401 through and/or into an optical polarization device 400 and a polarized laser light may be launched into an optical coupler 487. In embodiments, One output (e.g., a first output) of a coupler may pass through and/or be input to a circulator 402 and may pass through and/or be communicated to a WDM unit 491. In embodiments, outputs of the WDM unit 491 may be coupled and/or connected to N probes units 407 to 409 which may illuminate targets 1 unit 408 to target unit 410. In embodiments, reflected optical signals from a target 1 unit 408 to target unit 410 may be communicated through, pass through and/or go through probes 407 to 409 and then through WDM 491. In embodiments, outputs from WDM 491 may be passed through and circulated to a third port of a circulator 402. In embodiments, an other output (a second output) of the coupler 487 goes to another coupler 12. In embodiments, one output of the coupler goes to photodetector k+1 526 and an other output of the coupler goes to a WDM unit 494. The output from a third port of a circulator 402 may be passed through, communicated to and go to WDM unit 495. In embodiments, an output of the WDM units 494 may pass through and/or be communicated to WDM units 406 to 496. In embodiments, an output of WDM units 495 may be combined with an output of WDM units 492 to 497. In embodiments, the outputs of the WDM unit 406 may be combined with the corresponding outputs of WDM unit 492 using couplers 489 to 490 and then recombined in WDM unit 493. Likewise, the outputs of the WDM unit 46 may be combined with the corresponding outputs of WDM unit 497 using couplers 498 to 499 and then recombined in WDM unit 500. In embodiments, outputs of WDM units 493 to 500 may pass through and/or be communicated to Time-Stretch Dispersive Fourier Transform systems 1 to k, with an optional EDFA or Raman amplifier. In embodiments, an output of each TSDFT system may be photo detected using photo detector element 24 to 26. In embodiments, an output of photo detector element 24 to 26 may be digitized using a multi-channel analog to digital converter element 32. In embodiments, a digital post processing 16 in unit 485 may be utilized to obtain and/or calculate multiple spectrums captured by the probes and calculate distance of target captured by the probes.

The foregoing has outlined rather broadly certain aspects of the present invention in order that the detailed description of the invention that follows may better be understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

While the present system and method has been disclosed according to the preferred embodiment of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise. The term “connected” means “communicatively connected” unless otherwise defined.

When a single embodiment is described herein, it will be readily apparent that more than one embodiment may be used in place of a single embodiment. Similarly, where more than one embodiment is described herein, it will be readily apparent that a single embodiment may be substituted for that one device. None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

Methods, systems, devices (computing devices, processors and/or controllers), and units (e.g., units, algorithm units, WDM units, and/or other units) in accordance with exemplary embodiments can be hardware embodiments, software embodiments or a combination of hardware and software embodiments. In one embodiment, the methods described herein are implemented as software. Suitable software embodiments include, but are not limited to, firmware, resident software and microcode. In addition, exemplary methods and systems can take the form of a computer program product accessible from a computer-usable or computer-readable medium providing program code for use by or in connection with a computer, logical processing unit or any instruction execution system. In one embodiment, a machine-readable or computer-readable medium contains a machine-executable or computer-executable code that when read by a machine or computer causes the machine or computer to perform a method for spectral analysis of seismic data in accordance with exemplary embodiments and to the computer-executable code itself. The machine-readable or computer-readable code can be any type of code or language capable of being read and executed by the machine or computer and can be expressed in any suitable language or syntax known and available in the art including machine languages, assembler languages, higher level languages, object oriented languages and scripting languages.

As used herein, a computer-usable or computer-readable medium can be any apparatus that can contain, store, communicate, propagate, or transport the program for use by or in connection with the instruction execution system, apparatus, or device. Suitable computer-usable or computer readable mediums include, but are not limited to, electronic, magnetic, optical, electromagnetic, infrared, or semiconductor systems (or apparatuses or devices) or propagation mediums and include non-transitory computer-readable mediums. Suitable computer-readable mediums include, but are not limited to, a semiconductor or solid state memory, magnetic tape, a removable computer diskette, a random access memory (RAM), a read-only memory (ROM), a rigid magnetic disk and an optical disk. Suitable optical disks include, but are not limited to, a compact disk-read only memory (CD-ROM), a compact disk-read/write (CD-RNV) and DVD.

Although the features and elements of the present exemplary embodiments are described in the embodiments in particular combinations, each feature or element can be used alone without the other features and elements of the embodiments or in various combinations with or without other features and elements disclosed herein. The methods or flowcharts provided in the present application may be implemented in a computer program, software, or firmware tangibly embodied in a computer-readable storage medium for execution by a geo-physics dedicated computer or a processor.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims. Additionally, the language used in the specification has been principally selected for readability and instructional purposes, and it may not have been selected to delineate or circumscribe the inventive subject matter. It is therefore intended that the scope of the embodiments be limited not by this detailed description, but rather by any claims that issue on an application based hereon. Accordingly, the disclosure of the embodiments is intended to be illustrative, but not limiting, of the scope of the disclosure, which is set forth in the following claims.

Finally, in the claims, reference to an element in the singular is not intended to mean “one and only one” unless explicitly stated, but rather is meant to mean “one or more.” In addition, it is not necessary for a device or method to address every problem that is solvable by different embodiments of the invention in order to be encompassed by the claims.

The flow charts and/or block diagrams disclosed herein shows the architecture, functionality, and operation of a possible implementation of various modules of software, hardware and/or combinations of hardware and software. In this regard, each block represents a module, segment, or portion of code, which comprises one or more executable instructions for implementing the specified logical function(s). It should also be noted that in some alternative implementations, the functions noted in the blocks may occur out of the order noted in the flowcharts and/or block diagrams. For example, two blocks shown in succession in the flowcharts and/or block diagrams may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, such as for listed units and/or digital post processing units, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

When introducing elements or features of the present disclosure and the exemplary embodiments, the articles “a,” “an,” “the” and “said” are intended to mean that there are one or more of such elements or features. The terms “comprising,” “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a controller” “a microcontroller” “a microprocessor” and “a processor” or “the microprocessor” and “the processor” can be understood to include one or more microprocessors and/or controllers that can communicate in a stand-alone and/or a distributed environment(s), and can thus be configured to communicate via, wired or wireless communications with other processors and/or controllers, where such one or more processors and/or controllers can be configured to operate on one or more processor-controlled devices that can be similar or different devices. Furthermore, references to memory, unless otherwise specified, can include one or more processor and/or controller readable and accessible memory elements and/or components that can be internal to the processor-controlled device, external to the processor-controlled device, and/or can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as coming within the scope of the following claims. All of the publications described herein including patents and non-patent publications are hereby incorporated herein by reference in their entireties.

The foregoing description of the embodiments has been presented for the purpose of illustration; it is not intended to be exhaustive or to limit the disclosure to the precise forms disclosed. Persons skilled in the relevant art can appreciate that many modifications and variations are possible in light of the above disclosure.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device, system, and/or unit selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

In the claims, reference to an element in the singular is not intended to mean “one and only one” unless explicitly so stated, but rather “one or more.” All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

Definitions

Source Signal may be defined as an optical signal with waveform.

Dispersive Element may be defined as an optical element with chromatic dispersive properties, otherwise known as group velocity dispersion.

Digital Post Processing unit may be a device, apparatus or system that may process digital electrical signals, either in dedicated hardware or using software running on a central processing unit (CPU).

Time-Stretch Spectrometer may be an instrument that enables measurement of optical spectrum in single-shot and with high-throughput meaning a high frame, otherwise known as update rate.

Time-Stretch Dispersive Fourier Transform (TS-DFT) may use a Dispersive Element to stretch a source signal in a time domain and at a same time it maps a Source Signal spectrum to a time domain.

Optical Combiner Device is an optical device that may combine multiple optical signals, it may have multiple inputs and at least one output.

Electrical Combiner Device may be an electrical device that combines multiple electrical signals, it may have multiple inputs and at least one output.

Wave-Division Multiplexers may be a device that multiplexes or de-multiplexes different optical wavelengths.

What is claimed is:

1. An apparatus to perform spectral measurements of real-time and single-shot spectral bands from multiple probes simultaneously, comprising:
a polarization device to receive an input signal and output an optical signal having a first polarization state, and
at least one Wavelength Division Multiplexing (WDM) device to split a short pulse spectrum into one or more individual spectral bands, and
an optical coupler to split an input optical source signal into a first optical signal communicated on at least one main channel and a second optical signal communicated on one secondary channel;
at least one Time-Stretch Dispersive Fourier Transform (TS-DFT) system, coupled to the at least one main channel, to stretch the first optical signal in time, to generate at least one main optical signal;
a secondary delay channel, coupled to the secondary channel, to generate a delayed reference optical signal based on the second optical signal;
one or more photodetectors, coupled to the at least one main channel and the optional secondary delay channel, wherein the at least one main optical signal are converted to at least one main electrical signal and the delayed reference optical signal is converted to a delayed reference electrical signal;
an analog-to-digital converter to receive the at least one main electrical signal and the delayed reference electrical signal to at least one digital main electrical signal and at least one digital delayed electrical signal; and
a digital post processing system, to process the at least one digital main electrical signal and the digital delayed electrical signal, to calculate an input optical spectrum received from multiple probes, and to extract absolute wavelength information related to the spectrum received from multiple probes.

2. The apparatus of claim 1, wherein the optical polarization device is an optical quarter wave plate or an optical polarizer.

3. The apparatus of claim 1, wherein optical spectral measurement with absolute wavelength is used for an application of time-stretch optical coherence tomography to measure a reflection spectral interference with absolute wavelength from multiple OCT probes using a WDM device.

4. The apparatus of claim 1, wherein optical spectral measurement with absolute wavelength is used for an application of time-stretch optical coherence tomography to measure a sample image as well as a reflection spectrum from the sample image.

5. The apparatus of claim 1, wherein optical spectral measurement with absolute wavelength is used for an application of multiple acoustic vibrometric measurements on a 2D surface.

6. The apparatus of claim 1, wherein optical spectral measurement with absolute wavelength is used for an application of time-stretch imaging to measure a reflection spectrum with absolute wavelength from multiple probes combined using a WDM device.

7. The apparatus of claim 1, wherein optical spectral measurement with absolute wavelength is used for an application of time-stretch velocimetry, vibrometry or broadband laser ranging to measure spectral interference with absolute wavelength from multiple probes combined using a WDM device.

8. The apparatus of claim 1, further comprising additional multiple pulse generator devices to receive an input source signal, the multiple pulse generator devices to output multiple pulses with time delays in order to increase the repetition rate of the input source signal.

9. The apparatus of claim 1, further comprising an optical hybrid, the optical hybrid to utilize coherent detection instead of direct photo detection.

10. The apparatus of claim 1, wherein optical spectral measurement with absolute wavelength is used for an application of optical time-domain reflectometry (OTDR) with multiple probes.

11. The apparatus of claim 1, wherein digital post processing further comprises utilizing relative movement and/or relative phase changes in a Fourier domain of fringes with respect to the delayed reference optical signal or to other WDM signals, to calculate a velocity of a target.

12. An apparatus to perform spectral measurements of real-time and single-shot spectral bands from multiple probes simultaneously, comprising:
a polarization device to receive an input signal and output an optical signal with a first polarization state;
at least two Wavelength Division Multiplexing (WDM) devices to introduce multiple time delays among at least two WDM signals to capture corresponding signal interference at different time ranges for the at least two WDM signals;
an optical coupler to split an input optical source signal into at least one main optical channel and at least one secondary channel, a first optical signal communicated on at the least one main channel and a second optical signal communicated on the secondary channel, and
at least one Time-Stretch Dispersive Fourier Transform (TS-DFT) system, coupled to the at least one main optical channel, to stretch the first optical signal in time to generate at least one main optical signal, and
a secondary delay channel coupled to the secondary channel to generate a delayed reference optical signal based on the second optical signal, and
one or more photodetectors coupled to the at least one main channel and the optional secondary delay channel, wherein the at least one main optical signal is converted to at least one main electrical signal and a delayed reference optical signal is converted to a delayed reference electrical signal, and
an analog-to-digital converter to receive the at least one main electrical signal and the delayed reference electrical signal, to convert the at least one main electrical signals to at least one digital main electrical signal, and to convert the delayed reference electrical signal to a digital delayed electrical signal; and
a digital post processing system to process the at least one digital main electrical signal and the digital delayed electrical signal, to calculate an input optical spectrum received from multiple probes, and to extract absolute wavelength information related to the input optical spectrum received from the multiple probes.

13. The apparatus of claim 12, wherein optical spectral measurement with absolute wavelength is used for an application of time-stretch optical coherence tomography to measure a reflection spectral interference with absolute wavelength as well as a sample image from multiple OCT probes combined using a WDM device.

14. The apparatus of claim 12, wherein optical spectral measurement with absolute wavelength is used for an application of multiple acoustic vibrometric measurements on a 2D surface.

15. The apparatus of claim 12, wherein optical spectral measurement with absolute wavelength is used for an application of time-stretch imaging to measure a reflection spectrum with absolute wavelength from multiple probes combined using a WDM device.

16. The apparatus of claim 12, wherein optical spectral measurement with absolute wavelength is used for an application of time-stretch velocimetry, vibrometry or broadband laser ranging to measure spectral interference with absolute wavelength from multiple probes combined using a WDM device.

17. The apparatus of claim 12, further comprising an optical hybrid, the optical hybrid to utilize coherent detection instead of direct photo detection.

18. The apparatus of claims 12, wherein optical spectral measurement with absolute wavelength is used for an application of optical time-domain reflectometry (OTDR) with multiple probes.

19. The apparatus of claim 12, wherein the digital post processing further comprises utilizing relative movement and/or relative phase changes in a Fourier domain of fringes with respect to the second optical signal or to other WDM signals, to calculate the velocity of a target.
